(19) United States
(12) Patent Application Publication
(10) Pub. No.: US 2026/0278095 A1
(43) Pub. Date: Sep. 17, 2026

(54) SYSTEM AND METHOD FOR DISTRIBUTED SYSTEM AND METHOD OF RANSOMWARE DETECTION AND RECOVERY

(71) Applicant: Robert Bosch GmbH, Stuttgart (DE)

(72) Inventors: Jorge GUAJARDO MERCHAN, Pittsburgh, PA (US); Sashidhar JAKKAMSETTI, Sunnyvale, CA (US); Sekar KULANDAIVEL, Pittsburgh, PA (US); Stefan GEHRER, Pittsburgh, PA (US); Shalabh JAIN, Pittsburgh, PA (US); Pradeep M. PAPPACHAN, Pittsburgh, PA (US)

(21) Appl. No.: 19/079,755

(22) Filed: Mar. 14, 2025

(51) Int. Cl. G06F 21/56; G06F 21/53; G06F 21/60

(52) U.S. Cl. CPC G06F 21/564; G06F 21/53; G06F 21/602

(57) ABSTRACT

A distributed system for ransomware detection and recovery includes a first processor programmed to utilize a circuit to collect power measurements from one or more side-channel measurements of one or more devices, a second processor located at a detection agent and in communication with the first processor via a first secure communication channel, wherein the second processor is programmed to output results indicating ransomware associated with the one or more side-channel measurements, and a third processor located at an attestation agent and in communication with the second processor via a second secure communication channel, wherein the third processor is programmed to allow authorized access of the results from the second processor.

### TECHNICAL FIELD

The present disclosure relates to intrusion detection systems, such as those that may include a distributed system.

### BACKGROUND

Ransomware is a special type of malware affecting computers on the principle of hijacking data files on devices, making them inaccessible and unusable. Based on the employed methodology, ransomware is generally classified into two types, namely cryptographic ransomware that encrypts the victim files, and locker ransomware that prevents victims from accessing their systems by encrypting some of the files needed for the system to boot (some works identify a third form of ransomware that scares victims into paying a ransom, but for the purposes of this IR this is not really relevant). The deployers of the ransomware typically demand a ransom payment to restore the files to the user or organization. Examples of some recent ransomware attacks are WannaCry, Petya, NotPetya. DarkSide, etc.

When a ransomware attack occurs, the victim may receive a malicious payload, either via email, through web browser or direct transfer via a machine connected to the network. The malicious payload may be executed. The ransomware may generate a cryptographic key that is used for encryption of the victim's files. Over the course of time, the details of the management and nature of the key have changed. Earlier variants would simply use an asymmetric key pair, e.g. RSA key pair and encrypt the files using the public component. Newer variants typically use a symmetric key. This key may be hard-coded in the malware or kept stored locally on disk by the malware. More recent variants generate a local key. The key is protected using an asymmetric key that is protected by a key known to the server. The ransomware may encrypt all the files using the generated key(s). The ransomware displays a screen warning the user of the attack and demanding payment. Upon completion of the payment, the ransomware receives the decryption keys and recovers the files. The means of receiving the decryption key vary based on the malware.

In some variants, the ransomware will try to connect to a Command and Control Center to get private keys to decrypt or public keys or encryption to encrypt or send encrypted payloads. In most scenarios, the ransomware targets personal files and business relevant files, typically identified based on pre-known conditions, for encryption. Due to its anonymous nature, cryptocurrency, such as Bitcoin is often used for payment of the ransom.

### SUMMARY

According to a first embodiment a distributed system for ransomware detection and recovery includes a first processor programmed to utilize a circuit to collect power measurements from one or more side-channel measurements of one or more devices, a second processor located at a detection agent and in communication with the first processor via a first secure communication channel, wherein the second processor is programmed to output results indicating ransomware associated with the one or more side-channel measurements, and a third processor located at an attestation agent and in communication with the second processor via a second secure communication channel, wherein the third processor is programmed to allow authorized access of the results from the second processor.

According to a second embodiment, a distributed system for ransomware detection and recovery includes a first processor programmed to utilize a circuit to collect power measurements from one or more side-channel measurements of one or more devices, a second processor located at a detection agent and in communication with the first processor via a first communication channel, wherein the second processor is programmed to output results indicating ransomware associated with the one or more side-channel measurements at one or more devices, a third processor located at an attestation agent and in communication with the second processor via a second communication channel, wherein the third processor is programmed to allow authorized access of the results from the second processor, and a fourth processor in communication with the second processor, wherein the fourth processor is isolated from the second processor and programmed to receive a subset of workload from the second processor to assist in detecting ransomware.

According to a third embodiment, a distributed system for ransomware detection and recovery including a first processor programmed to utilize a circuit to collect power measurements from one or more side-channel measurements of one or more devices, a second processor located at a detection agent and in communication with the first processor via a first one-way communication channel, wherein the second processor is programmed to output results indicating ransomware utilizing with the one or more side-channel measurements, a third processor located at an attestation agent and in communication with the second processor via a second communication channel, wherein the third processor is programmed to allow authorized access of the results from the second processor, and a fourth processor in communication with the second processor, wherein the fourth processor is isolated from the second processor and programmed to receive a subset of workload from the second processor to assist in detecting ransomware, wherein the first processor, the second processor, the third processor, and the fourth processor are different processors in isolated environments.

### BRIEF DESCRIPTION OF THE DRAWINGS

FIG. 1 illustrates a flowchart of an exemplary method performed by some disclosed embodiments.

FIG. 2 illustrates an embodiment of a distributed system 200 for a ransomware collector.

FIG. 3 illustrates an alternative embodiment of a distributed system architecture in a ransomware detection and recovery system with an additional component utilizing detection workers and recovery workers.

FIG. 4 illustrates an alternative embodiment of a distributed system that includes a feedback loop.

FIG. 5 illustrates an exemplary computing system according to some disclosed embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In this disclosure, the system and method describes a novel system and associated methods to enable detection of ransomware attacks and possibly recover the keys used by the ransomware into a secure environment. In contrast to many prior systems, this may be done in a distributed fashion. This brings forth many advantages.

One example may be that the usage of distributed power analysis method to identify the attack (encryption of certain files in the file system). While there is a need to physically collect measurements from the target machine, the analysis of whether the potentially anomalous behavior is done remotely, has certain advantages. First, it may protect the analysis method from malicious competitors, trying to reverse engineer the techniques used to detect and/or recover from the ransomware attack. If keys are recovered, the keys are kept in a secure environment. If detection is the aim, then by aggregating the measurements from multiple devices, one can potentially get a higher confidence that an attack is happening across the network and it is not a false positive (false positive reduction)

By decoupling the detection from the collection process, it is possible for multiple detection agents to efficiently share expensive resources, like GPUs (for machine learning (ML) inference algorithms) instead of provisioning every collection agent with such resources for performing detection.

The distributed framework allows the decision making agent to temporarily alter the parameters of the detection agents based on detection conditions, allowing faster detection of ransomware activity. As a result of collected samples from multiple agents, the decision agent may be able to make faster decisions on the presence of ransomware, or converge to a higher confidence quickly.

The system design has unique out of band collection network. The system and method does not need to be integrated into the operating system (OS) that the ransomware will infect and therefore there is no need to assume that the method to detect ransomware runs at higher privilege level. Thus, even if the ransomware compromises the higher privilege levels of the OS, the system and method described below will have the ability to detect and recover the keys encrypted by the ransomware.

Another advantage of the system and method is that it does not require modification of the operating system (OS) of the system that is trying to be protected. It also does not need modification of the cryptographic services used to generate randomness or encrypt data (typically used by ransomware). Thus, it can be applied externally to a running system without any additional modification. Because of such a design, the technique would be hard to be identified by an attacker (a common technique used by attackers to stop an attack). Previous systems and methods may mostly try to detect the ransomware and stop before it causes damage to the system that it has infected. In the case of the embodiments disclosed below, the system and method may detect the attack and also recover the key. The system and method may propose a service based on the method proposed here to detect and recover keys used to encrypt files by a given ransomware.

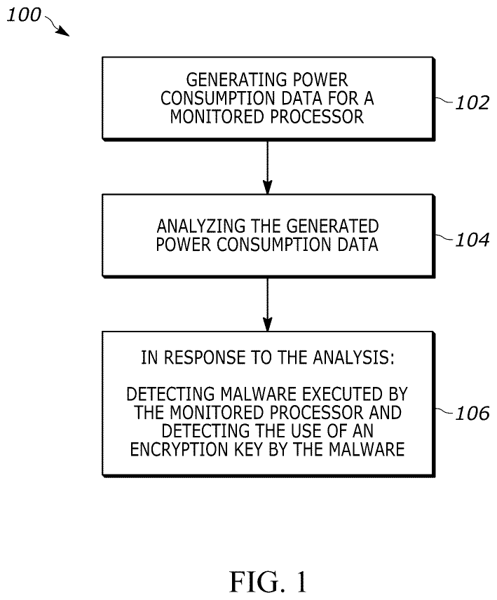

FIG. 1 illustrates a flowchart of an exemplary method 100 performed by some disclosed embodiments. In some embodiments, the steps 102, 104, and 106 may be performed sequentially. In some embodiments, two or more of the steps 102, 104, 106 may be performed simultaneously. For example, the analyzing of the generated power consumption data 104 may be performed as the consumption data is being generated 102. Additionally, the operations of detecting malware and detecting a use of an encryption key may be performed simultaneously in some disclosed embodiments. In some embodiments, the steps 102, 104, and 106 may be reordered.

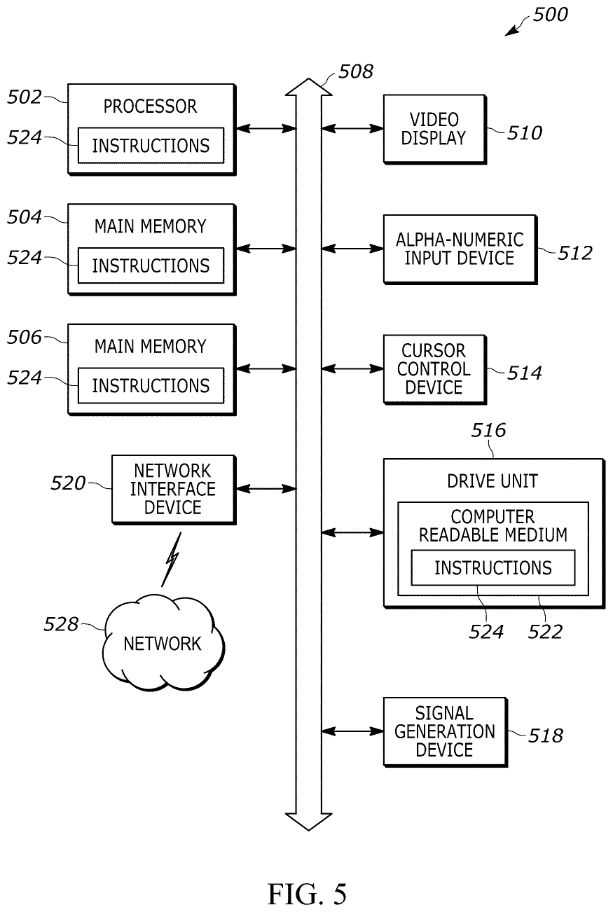

In step 102, power consumption data is generated for a monitored processor. A monitored processor may be any processor of a system that may be subject to a malware attack. For example, the monitored processor may be a processor (e.g., a CPU) included in a personal computer, a desktop computer, a mobile computer, a laptop computer, a notebook computer, a terminal, a workstation, a server computer, a Personal Digital Assistant (PDA) device, a tablet computer, an electronic control unit (“ECU”), a network device, or any other suitable computing device. Such systems may also include a plurality of input units, a plurality of output units, a plurality of memory units, a plurality of storage units, and/or other suitable hardware components and/or software components. For example, a system as described herein may include one or more devices such as computing device 500 shown in FIG. 5.

While power consumption data is utilized in one embodiment, this data may not be limited as to how it is collected. For example, the data may be collected from many other modalities of information such as electromagnetic (EM) radiation, sound, heat, etc. Furthermore, any number of modalities may be utilized. Another source of potential power consumption may include the power consumption measured from the network adapters (Ethernet adapter, or USB adapters, or any other adapters available in the monitored device). For example in a vehicle ECU, it can be collected utilizing CAN transceivers.

In some embodiments, a system may include or may be, for example, a plurality of components that include a respective plurality of CPUs, e.g., a plurality of CPUs as described, a plurality of CPUs embedded in an on board, or in-vehicle, system or network, a plurality of chips, FPGAs or SOCs, microprocessors, transceivers, microcontrollers, a plurality of computer or network devices, any other suitable computing device, and/or any combination thereof.

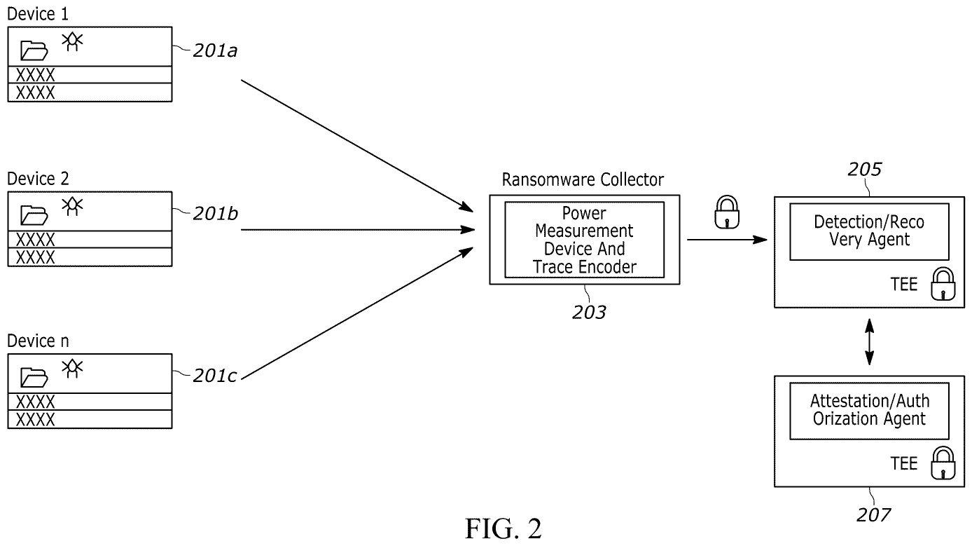

FIG. 2 discloses an illustrative embodiment of a distributed system 200 for a ransomware collector. The ransomware collector 203 may be split into multiple functional services. For example, the power measurement device can optionally encode measured power consumption traces into a frequency response representation such as Mel coefficients. The system may send these via a secure channel to the detection/recovery service, which is optionally implemented using a trusted execution environment (TEE).

The physical measurement that is obtained may be a side-channel measurement (e.g. a circuit to measure power) of one or more devices 201a, 201b, 201c that can be attacked by ransomware, such as a consumer PC, automotive PC, industrial controller, or personal phone. The circuit may include a shunt resistor in series with the power rails of the main processor and a small, dedicated processor and storage to process the observed power data, store it. Alternatively, the device can be a dedicated external device. The system may utilize such information to determine if malware, such as ransomware is present. This is described in detailed in U.S. Patent Publication No. 2024/0330459, entitled “METHODS AND SYSTEMS FOR PROTECTING COMPUTER SYSTEMS FROM ENCRYPTION-BASED MALWARE,” which is incorporated in reference by its entirety herein. For example, any type of sensor may be used in addition to a shunt resistor. For example, in one embodiment, sensor may be implemented as shunt resistor (and more generally, an impedance) in line with the power bus, for AC and/or DC measurements. Electromagnetic sensors are also possible and contemplated, with variations in a magnetic field converted into a voltage. Other possible sensor implementations include a transformer-based current clamp for AC measurements, a hall-sensor based current clamp for AC and DC measurements, temperature-based measurements (temperature distribution of the CPU and/or overall processor(s) while processing; temperature of resistor/impedance in line with power supply, ambient temperature of machine e.g. at fans), vibration measurements, and/or sound measurements. Another possible implementation of a sensor circuit includes a Rogowski coil (which comprises an air core toroidal coil), a fluxgate magnetometer, various types of DC current measurement circuits (when the power passing through is DC power), and so on. In general, any type of sensor apparatus capable of sensing variations in the power passing is possible and contemplated. Embodiments including a combination of different sensor types are also possible and contemplated

The system may be implemented in a distributed system manner, which results in the advantages listed above. In one embodiment, a first step shows that the Ransomware Monitor device 203 can be split into at least two clearly distinct functionality services as shown in FIG. 2. In FIG. 2, one can see that the ransomware monitor is split into two different services hosted in different devices. The power measurement circuit and optional trace encoder may be hosted on one device with a dedicated processor or controller, while the analysis and detection service 205 is hosted in a different system with a different set of processors and software, which is optionally hosted remotely (possibly in a cloud environment). The system may have processors that have isolate environments, such as different processes, different threads, and different cores that are focusing on the distinct functionality.

A trace encoder may be used in collecting side-channel power measurements from a device. The trace encoder may plays a role in capturing, processing, and preparing power consumption data for analysis in identifying a ransomware attack. The trace encoder may interface with measurement equipment, such as a shunt resistor, oscilloscopes, or analog-to-digital converters (ADCs), to acquire data that reflects power usage variations as the device performs specific operations. The encoder may apply initial signal processing techniques, including filtering to reduce noise, amplification to enhance signal resolution, and down-sampling to manage data rates efficiently. After acquisition, the trace encoder may convert raw analog or digital samples into a structured format, which may involve compression algorithms to reduce data size, in a manner without losing critical information or feature extraction to highlight key characteristics for simplified analysis. Additionally, the trace encoder may synchronize power traces with specific device events or instructions, allowing for precise correlation between power consumption patterns and internal activities, such as cryptographic computations. The encoded traces may be stored or transmitted to a host system for further analysis, typically in the context of side-channel attacks where the goal may be to uncover hidden information through subtle power consumption patterns.

The trace encoder can be augmented with additional information, if the additional information is available. This additional information could include the types of applications or programs that are expected to be run on the device being monitored. These could be provided in a whitelist. It could also include a listing of the expected timing characteristics or requirements of the applications/programs running on the monitored device. Timing properties could include average time, as well as worst case timing. Other type of important information could include the expected or most probably order in which certain programs or applications will operate.

The system may also include an attestation/authorization agent 207. The attestation agent 207 may be a separate processor and device from the other devices in the system. The attestation agent 207 may be a part of a Trusted Execution Environment (TEE). The attestation agent 207 may be in communication with the detection and recovery agent, but may also be isolated from the ransomware collector 203 in another embodiment.

There are multiple advantages associated with this distributed system architecture in such an embodiment. In particular, by hosting the analysis and detection/recovery service in a different system, one can protect the algorithms used to analyze/detect/recover from a ransomware attack in a secure environment, which is not subject to reverse engineering by malicious actors or competitors. The analysis/detection/recovery service can be hosted in a Trusted Execution Environment (TEE), which has the advantage of offering additional security, logging, and monitoring capabilities. For example, a third party service can approve and verify that what the service functionality does or where it is originating from (which entity is offering the service). Thus, a TEE may not be optional for the power measurement device and trace encoder.

The TEE may be a secure area within a device's main processor designed to ensure the confidentiality and integrity of sensitive code and data. It may rely on a combination of specialized hardware and software components to create an isolated environment, separate from the main operating system. On the hardware side, TEEs may typically utilize secure processors or co-processors, such as ARM's TrustZone or Intel's Software Guard Extensions (SGX), which enable the segregation of secure and non-secure operations. Memory isolation mechanisms may be utilized to ensure that sensitive data stored within the TEE cannot be accessed by unauthorized applications running in the standard operating environment. Additionally, dedicated cryptographic engines may handle encryption, decryption, and key management efficiently, while secure boot mechanisms verify the integrity of the system from the moment it powers on, preventing the execution of untrusted code. Physical security measures, like tamper-resistant hardware modules or Trusted Platform Modules (TPMs), further strengthen the TEE against physical attacks.

The software stack within a TEE may also provide secure access. At its core is a lightweight, secure operating system—such as OP-TEE or Trusty OS—that manages the secure environment. Trusted Applications (TAs) run within this OS to handle sensitive operations, like payment processing or biometric authentication, securely isolated from the main system. Standardized APIs, such as those defined by GlobalPlatform, facilitate controlled communication between the Rich Execution Environment (REE) and the TEE, ensuring that data exchanged across these boundaries remains secure. Cryptographic libraries embedded within the TEE provide robust tools for key management, secure data storage, and encrypted communications. Additionally, attestation mechanisms are employed to verify the integrity of the TEE, particularly in remote attestation scenarios where proving the trustworthiness of the device to an external party is necessary. Popular implementations of TEEs include ARM TrustZone, Intel SGX, Intel TDX, Apple's Secure Enclave, and AMD's Secure Encrypted Virtualization (SEV), each tailored to specific use cases but built on the same foundational principles of hardware-backed security and software isolation.

In addition, in the case of recovery, the TEE recovery service can protect the recovered keys and allow authorized access to only those parties authorized by the policy governing the TEE. The ransomware collector may also store the collected traces in a separate storage for a certain amount of time. In case a detection/recovery agent needs more data or has updated algorithms, it could request the data again (or additional data) from the ransomware collector to improve detection or recovery accuracy.

In one embodiment, there may be multiple different devices that act as multiple ransomware collector systems. In one embodiment, a system and method can set up two devices connected to all devices through any number of devices via multiple measurement channels. In this case, the ransomware collector boxes would act in fail-safe mode, in such a way that if one fails, the other would be able to react and continue measuring. In another embodiment, the TEE is one manner to implement the detection/recovery agent to add security to the architecture. An alternative to do this can be to deploy this agent in a dedicated separate network or using multi-party secure computation to perform its work load.

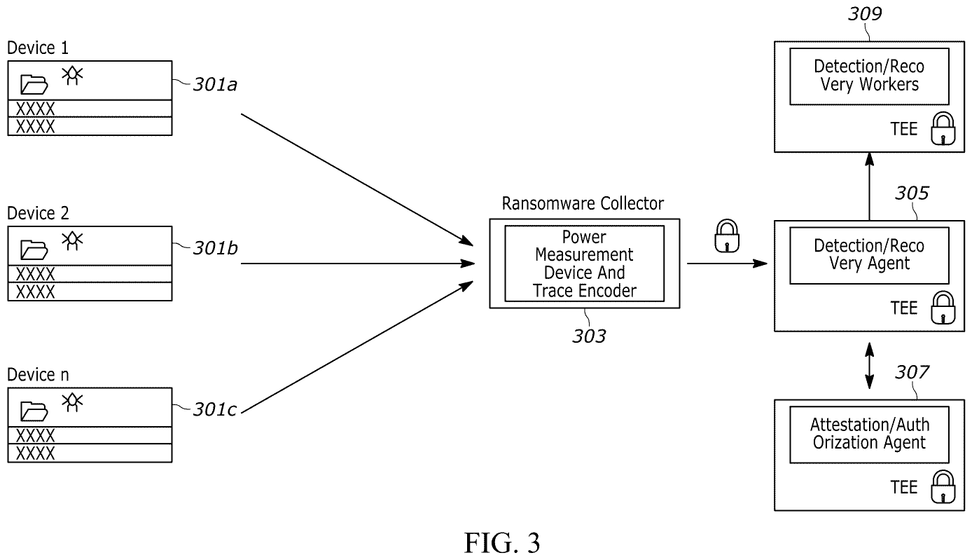

FIG. 3 is an alternative embodiment of a distributed system architecture in a ransomware detection and recovery system with an additional component utilizing detection and recovery workers. A different embodiment adds workers to the detection/recovery service agent as shown in FIG. 3 As shown, multiple target devices may be tested. In one distributed system, there may be a ransomware collector. The ransomware collection may include a power measurement device and trace encoder. The physical measurement interface may collect side-channel information via a channel that cannot be controlled by an attacker (wires, antenna, etc.). While the ransomware collector may be done a single device, it can be split into multiple distributed systems. For example, one portion may collect power utilizing a power measurement device, and the other is a trace encoder.

In FIG. 3, the analysis/detector/recovery agent also offloads the computation to worker nodes. These nodes provide additional specialized functionality or additional computer power. Examples of their functionality could be to specialize different worker nodes based on types of ransomware. In particular, different types of ransomware might encrypt using different encryption methodologies, thus one could deploy different models that have been tuned for each encryption method. No need to detect the encryption method. One could hypothesize that the one method that provides the highest confidence level is the one that has been used to encrypt. While such an approach does not have a significant advantage in detecting ransomware, it could offer a significant advantage in recovering from a particular ransomware variant, given that different ransomware families might use different encryption methods. A different way to use worker nodes is in the deployment of key searching, where after some initial reduction in the key space by methods described in different disclosure, one can perform exhaustive key search on the remainder key candidates.

In another embodiment the central detection/recovery agent could learn from events in real-time. In case there is a mechanism (e.g. circuit) to verify that a possible intrusion on a first device is actually an active ransomware, the algorithms could be updated to better capture the intrusion on a second device (or other connected devices) as well. Instead of having to update algorithms on each of the devices (i.e. prior systems), the system can immediately use the updated signature for all devices. The system could, furthermore, correlate measurements from multiple devices. In case there is a coordinated ransomware attack on multiple devices protected by the system and method disclosed, the system could improve accuracy in detecting the attack. In case the keys used by the ransomware are correlated between the different devices, the system could also improve our accuracy in recovering the used keys in the ransomware attack in order to be able to decrypt the affected files.

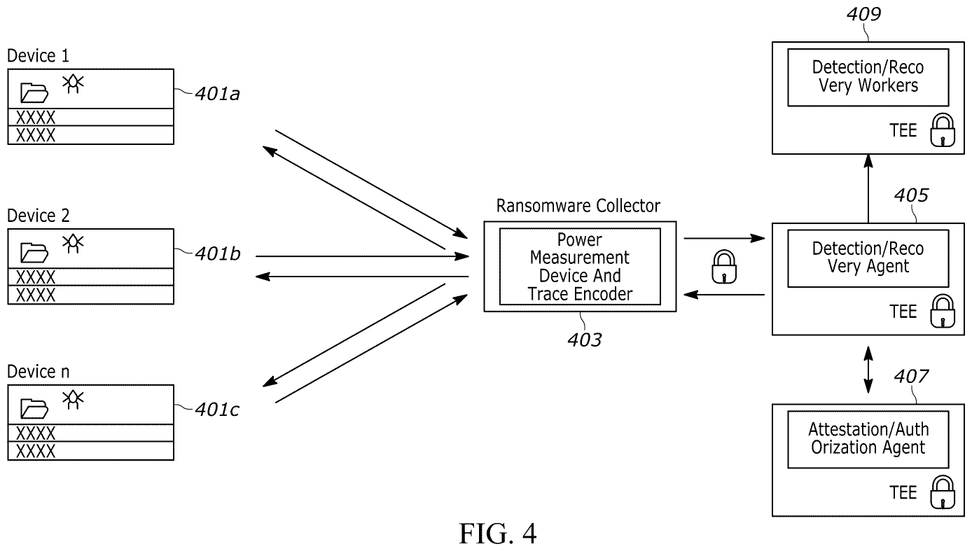

FIG. 4 illustrates an alternative embodiment of a distributed system that includes a feedback loop. The feedback loop may allow for an appropriate response to be sent back to the ransomware collector devices, which in turn send an appropriate response signal to each infected device. In this alternative embodiment, the system adds functionality to allow for a countermeasure in response to the detection of the malware. Once a detection is raised, the reaction will be communicated back to the ransomware collector(s), which in turn will distribute the appropriate response to the end devices. In case of a coordinated attack on multiple devices is detected, a global reaction could be triggered, such as turning-off all devices at the same time or disconnecting the devices from a particular network and connecting those devices to a network meant for cleaning or investigating potentially compromised hosts.

The distributed system 400 may obtain physical measurements from multiple devices 401a, 401b, 401c. The physical measurement interface may collect side-channel information via a channel that cannot be controlled by the attacker (such as wires, or antennas). The communication between the devices and the ransomware collector may be two-way, as an appropriate action based on the detection system (e.g. shutdown system, etc.) may occur.

The ransomware collector 403 may include a power measurement device and trace encoder. While only one box is shown in 403, multiple devices may be utilized for this functionality. Multiple devices may increase cost but provide fault tolerance in case of malfunction or attacks. The multiple devices may share and/or split functionality in one embodiment. The ransomware collector 403 may be in communication with a detection agent/recovery agent 405. The communication channel may be assumed to be secure. The feedback related to detection and the collector may react accordingly.

The detection agent/recovery agent 405 may be part of a TEE. The detection agent 405 may implement detection logic that aggregates information from multiple devices. The information may be received from the ransomware collector 403. The detection agent 405 may also be programmed to distribute work to the workers.

In some embodiments, ransom ware may be able to infect multiple machines at the same time. For example in the recent Kadokawa attack, the BlackSuit ransomware infected a single server and spread across multiple servers over a month's time, then launched a distributed attack encrypting essential files all at once (e.g. within a few hours). In such cases, all infected machines tend to act at the same time because they do not want to alert any defense mechanisms which could potentially increase the security for all other machines. The embodiment disclosed which includes a distributed architecture may be specifically useful for such cases (e.g. Kadokawa attack or similar). If our system notices that a subset of machines are indicating presence of ransomware activity at the same time (or within a small gap), the system can execute a few countermeasures.

One countermeasure may be to possibly suspend all of the various devices preemptively, assuming that most of them must have been infected. In another embodiment, the system may reduce the detection window, which is the time window used by the Detection Agent to analyze a segment of the power trace and flag if it has ransomware-to quickly conclude it as ransomware attack and stop them. Note that reducing the detection windows is proportional to the number of files saved from being corrupted. There may be multiple ways of executing this. In one example, the system may assume it has N machines attached to the detection agent, and the initial detection window is T seconds. If the agent finds k (out of N) machines showing signs of ransomware in quick succession, then the window can be reduced to T/k seconds, to ensure the system can decide preemptively and stop all N if the agent is highly confident that it is ransomware attack. In particular, the algorithm used by the agent may update its detection probability every t second intervals (much smaller than T). As soon as window becomes T, the agent takes an action if the combined detection probability is above a predetermined threshold. Now in this distributed variant, the agent need not wait until T seconds, rather only T/k seconds to take an action.

In another embodiment, the system may have the feedback loop adjust sampling rate or detection thresholds. In such embodiments, the agent collecting power data may have adjustable parameters, such as sampling rate, pre-processing gains, etc. The parameters can be tuned to an optimal balance between the volume of data collected and detection performance. Additionally, in several embodiments the detection algorithm may raise an alert for detection once the confidence of prediction reaches a certain threshold. In these embodiments, the detection algorithm defines an additional lower threshold for tuning the adjustable collection agent parameters. Once the confidence of the prediction reaches the lower threshold, the detection agent triggers feedback to the collection agent to increase the sampling rate and pre-processing gain. This may enable faster convergence to the final result, allowing early detection of ransomware activity.

Once the confidence of a positive ransomware prediction falls below the defined lower threshold, the detection agent sends a signal to the collection agents to restore the adjustable parameters to the default status. In some embodiments, the detection agent may have multiple lower thresholds, with each threshold defining a different set of parameters. In alternative embodiments, the detection agent may select a subset of collection agents for adjustment of parameters. The subset of agents may vary randomly over time or based on a fixed patterns.

Some embodiments may include on-the-fly model updates. By decoupling the collection agent from the detection agent, it is possible to update the models on the detection agents without disrupting the power trace collection process. For example, if a new detection model is available, it might be possible to migrate the detection agents running on some of the nodes temporarily to other nodes before updating the node with the new model. After the update process is completed, the workloads can be migrated to the node with new model. In this manner, rolling updates can be applied to the nodes running the detection agents without incurring any downtime or disruption to the detection process.

In another embodiment, one advantage may include that the distribute system may allow for updates over different organizations or geographical regions. As such, in some embodiments, the collection agents may be distributed over multiple organizations or geographical regions, each with its own policy for data exfiltration to a central decision agent. In such an embodiment, each organization or geographical region may have a local decision agent where the local model is updated using various methods. The local decision agents may send delta updates to a central decision agent using Federated Learning techniques.

In another embodiment, another improvement may include improved detection by coordination with storage servers. In datacenters, files are very often stored in remote network attached storage. When ransomware activity is in progress, the remote file servers may notice anomalous file activity. This information can be relayed to the detection agent, which can then transmit it with metadata (which may include time of activity, duration, etc.) to the worker nodes running the detection models. The detection algorithms can use this information from the storage servers to potentially improve the accuracy of their prediction and reduce false positive rates.

FIG. 5 shows a block diagram of an example embodiment of a general computer system 500. The computer system 500 can include a set of instructions that can be executed to cause the computer system 500 to perform any one or more of the methods or computer-based functions disclosed herein. For example, the computer system 500 may include executable instructions to perform operations disclosed herein, including the operations of method 100. The computer system 500 may be connected to other computer systems or peripheral devices via a network. Additionally, the computer system 500 may include or be included within other computing devices.

As illustrated in FIG. 5, the computer system 500 may include one or more processors 502. The one or more processors 502 may include, for example, one or more central processing units (CPUs), one or more graphics processing units (GPUs), or both. The computer system 500 may include a main memory 504 and a static memory 506 that can communicate with each other via a bus 508. As shown, the computer system 500 may further include a video display unit 510, such as a liquid crystal display (LCD), a projection television display, a flat panel display, a plasma display, or a solid-state display. Additionally, the computer system 500 may include an input device 512, such as a remote-control device having a wireless keypad, a keyboard, a microphone coupled to a speech recognition engine, a camera such as a video camera or still camera, or a cursor control device 514, such as a mouse device. The computer system 500 may also include a disk drive unit 516, a signal generation device 518, such as a speaker, and a network interface device 520. The network interface 520 may enable the computer system 500 to communicate with other systems via a network 528. For example, the network interface 520 may enable a machine learning system to communicate with a database server (not shown) or a controller in manufacturing system (not shown).

In some embodiments, as depicted in FIG. 5, the disk drive unit 516 may include one or more computer-readable media 522 in which one or more sets of instructions 524, e.g., software, may be embedded. For example, the instructions 524 may embody one or more of the methods or functionalities, such as the methods or functionalities disclosed herein. In a particular embodiment, the instructions 524 may reside completely, or at least partially, within the main memory 504, the static memory 506, and/or within the processor 502 during execution by the computer system 500. The main memory 504 and the processor 502 also may include

### Computer-readable Media.

In some embodiments, dedicated hardware implementations, such as application specific integrated circuits, programmable logic arrays and other hardware devices, can be constructed to implement one or more of the methods or functionalities described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, embodiments of the present disclosure may encompass software, firmware, and hardware implementations, or combinations thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or functionalities disclosed herein.

In some embodiments, some or all of the computer-readable media will be non-transitory media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A distributed system for ransomware detection and recovery, comprising:
a first processor programmed to utilize a circuit to collect power measurements from one or more side-channel measurements of one or more devices;
a second processor located at a detection agent and in communication with the first processor via a first secure communication channel, wherein the second processor is programmed to output results indicating ransomware associated with the one or more side-channel measurements; and
a third processor located at an attestation agent and in communication with the second processor via a second secure communication channel, wherein the third processor is programmed to allow authorized access of the results from the second processor.

2. The distributed system of claim 1, wherein the detection agent is in a trusted executable environment.

3. The distributed system of claim 1, wherein the second processor is located in a Trusted Execution Environment (TEE) that includes one or more hardware and software components isolated from a main operating system associated with the second processor.

4. The distributed system of claim 1, wherein the third processor is located in a Trusted Execution Environment (TEE) that includes one or more hardware and software components isolated from a main operating system associated with the third processor.

5. The distributed system of claim 1, wherein the one or more side-channel measurements are collected utilizing at least one or more shunt resistors, hall-sensor, electromagnetic sensor, transformer-based current clap, Rogowski coil, or fluxgate magnetometer.

6. The distributed system of claim 1, wherein the second processor is remote from the first processor in a different environment.

7. The distribute system of claim 1, wherein the first processor is further programmed to utilize a trace encoder configured to convert the one or more side-channel measurements into a structured format.

8. The distributed system of claim 1, wherein the first processor is not located in a Trusted Execution Environment (TEE).

9. A distributed system for ransomware detection and recovery, comprising:
a first processor programmed to utilize a circuit to collect power measurements from one or more side-channel measurements of one or more devices;
a second processor located at a detection agent and in communication with the first processor via a first communication channel, wherein the second processor is programmed to output results indicating ransomware associated with the one or more side-channel measurements at one or more devices;
a third processor located at an attestation agent and in communication with the second processor via a second communication channel, wherein the third processor is programmed to allow authorized access of the results from the second processor; and
a fourth processor in communication with the second processor, wherein the fourth processor is isolated from the second processor and programmed to receive a subset of workload from the second processor to assist in detecting ransomware.

10. The distributed system of claim 9, wherein the fourth processor is located in a Trusted Execution Environment (TEE).

11. The distributed system of claim 9, wherein the first processor and the second processor are a same processor.

12. The distributed system of claim 9, wherein the one or more devices include a consumer personal computer, an automotive electronic control unit (ECU), an industrial controller, or a mobile phone.

13. The distributed system of claim 9, wherein the first processor is further programmed to update one or more ransomware detection algorithms at one of the one or more devices.

14. The distributed system of claim 9, wherein the distributed system includes a feedback loop configured to output a countermeasure to one or more infected devices from the first processor.

15. The distributed system of claim 14, wherein the countermeasure includes one or more instructions to shut down a system at the one or more infected devices.

16. A distributed system for ransomware detection and recovery, comprising:
a first processor programmed to utilize a circuit to collect power measurements from one or more side-channel measurements of one or more devices;
a second processor located at a detection agent and in communication with the first processor via a first one-way communication channel, wherein the second processor is programmed to output results indicating ransomware utilizing with the one or more side-channel measurements;
a third processor located at an attestation agent and in communication with the second processor via a second communication channel, wherein the third processor is programmed to allow authorized access of the results from the second processor; and
a fourth processor in communication with the second processor, wherein the fourth processor is isolated from the second processor and programmed to receive a subset of workload from the second processor to assist in detecting ransomware, wherein the first processor, the second processor, the third processor, and the fourth processor are different processors in isolated environments.

17. The distributed system of claim 16, wherein the first processor utilizes a trace encoder to filter or compress the one or more side-channel measurements utilizing at least signal processing.

18. The distributed system of claim 16, wherein the fourth processor is programmed to utilize multi-party secure computation to assist in detecting ransomware.

19. The distributed system of claim 16, wherein the first processor, the second processor, the third processor, and the fourth processor are all located remotely from one another in unique networks.

20. The distributed system of claim 16, wherein the second processor, the third process, and the fourth processor are all located in a Trusted Execution Environment (TEE).
